(19) United States
(12) Patent Application Publication
(10) Pub. No.: US 2026/0290979 A1
(43) Pub. Date: Sep. 24, 2026

(54) MULTI-CELL BATTERY SYSTEM

(71) Applicants: Thomas McNiff, Cartersville, GA (US); David McCombs, Stanford, KY (US); Tanner Wynn, Dahlonega, GA (US)

(72) Inventors: Thomas McNiff, Cartersville, GA (US); David McCombs, Stanford, KY (US); Tanner Wynn, Dahlonega, GA (US)

(21) Appl. No.: 19/572,147

(22) Filed: Mar. 19, 2026

Related U.S. Application Data
(60) Provisional application No. 63/775,638, filed on Mar. 21, 2025.

(51) Int. Cl. H01M 50/258; H01M 10/42; H01M 10/48; H01M 50/204; H01M 50/244; H01M 50/262; H01M 50/507; H01M 50/51; H02J 7/00; H02J 7/50; H02J 7/52

(52) U.S. Cl. CPC H01M 50/258; H01M 10/4264; H01M 10/482; H01M 50/204; H01M 50/244; H01M 50/262; H01M 50/507; H01M 50/51; H02J 7/52; H02J 7/585; H02J 7/855; H01M 2010/4271

(57) ABSTRACT

A multi-cell cell system can include a cap, a rack, and a power system. The cap can be securable to a cell. The cap can be configured to receive a positive terminal and a negative terminal of the cell at least partially therethrough. The rack can be configured to receive the cell when the cap is secured to the cell to secure the cell to the rack. The power system can be connected to the rack and can be electrically connectable to the positive terminal and the negative terminal of the cell when the cell is received within the rack. The power system can deliver electrical power from the cell.

### CLAIM OF PRIORITY

This patent application claims the benefit of priority, under 35 U.S.C. Section 119(e), to Tom McNiff U.S. patent application Ser. No. 63/775,638, entitled “MULTI-CELL BATTERY SYSTEM,” filed on Mar. 21, 2025, which is hereby incorporated by reference herein in its entirety.

### BACKGROUND

Emergency and stored power systems employing Advanced Chemistry Cell (ACC) batteries are commonly used for power storage and power backup in applications including the telecommunications, recreational, industrial, home, solar power, marine, mobility, and other fields. As lithium and other ACC cells have progressed, individual cells are increasingly being used in batteries as sealed consumer products typically in 12, 24, 36, and 48-volt sealed packages. These packages are comprised of cells of various voltage and amp hours that scale to 12, 24, 36 or 48 volts.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an isometric view of a battery cell.

FIG. 2 illustrates an isometric view of a portion of a battery system.

FIG. 3 illustrates an isometric view of a portion of a battery system.

FIG. 4 illustrates an isometric view of a portion of a battery system.

FIG. 5 illustrates an isometric view of a portion of a battery system.

FIG. 6 illustrates an isometric view of a portion of a battery system.

FIG. 7 illustrates an isometric view of a portion of a battery system.

FIG. 8 illustrates a schematic view of a portion of a battery system.

FIG. 9 illustrates a schematic view of a portion of a battery system.

FIG. 10 illustrates a schematic view of a portion of a battery system.

FIG. 11 illustrates a schematic view of a method or use of a battery system.

FIG. 12 illustrates a block diagram illustrating an example of a machine upon which one or more embodiments may be implemented.

### DETAILED DESCRIPTION

As lithium and other Advanced Chemistry Cell (ACC) cells have progressed, individual cells are increasingly being used in batteries as sealed consumer products typically in 12, 24, 36, and 48-volt sealed packages. Advanced chemistry cell batteries, unlike their lead-acid counterparts, can use a battery management system to manage the charging, discharging, monitoring, and safety of the individual cells. These packages are comprised of cells of various voltage and amp hours that can scale to 12, 24, 36 or 48 volts. Most commercial ACC batteries are sealed, with no provision to replace an individual ACC cell. When a single cell in this pack fails to perform to specification, it renders the entire battery no longer fit to purpose and often the entire battery is replaced, along with its battery management system, copper interconnects, and casing. In an example where 16 3-volt batteries are used to create a 48-volt system, entire systems are replaced instead of replacing a single cell out of 16. Often, these components are not recycled, even though most of the battery is functioning properly. Since the entire battery is essentially thrown away, manufacturers make manufacturing decisions to reduce the cost of conductors by limiting the conductive cross section, leading to internal power losses which can result in suboptimal battery performance. Cost reduction decisions can also be made in the battery management system circuitry, choosing cheaper components and circuits, due to anticipated shorter life cycles, yielding sub-optimal overall management of the battery cells.

This disclosure includes devices, systems, and methods that can help to address these issues, such as by including a system that is not disposed of when a single cell fails. Instead, this disclosure describes a battery system that provides cell access, whereby individual cells can easily be removed and replaced with a new cell without having to connect wiring to disconnect or connect the cell from the battery system. The design enables an easy method of replacement for any individual cell in the battery even while the battery is in operation (e.g., the battery system allows for hot swapping of cells). The battery, its conductors, and battery management circuitry can be retained when a cell is replaced, which can help to reduce overall cost of maintenance and replacement.

Detection of failing cells and hot-swapping of individual cells can be facilitated by a battery management system that records data about the health of each cell and sends an alert or notification when cell health falls below a threshold. Indication that a cell should be replaced can be provided by data from the internal battery management system, which can indicate the deficient cell on a case or rack, such as in the form of an LED.

Since most of the battery system can be retained following cell replacement, relatively thicker material can be used for conductors to lower internal resistance. Also, higher quality components and circuitry can be used in the battery management system with a design that is optimized for efficiency, which can help to improve battery performance and management of each of the cells.

Further, the disclosed design describes a method for holding charge at the location of the cell with the poorest health, and a charge transfer method (from within the individual cells) whereby charge can be replenished to that location. The amount of charge transferred can be recorded, giving a better measure of state of charge (SOC) and state of health (SOH) than the typical battery measurement system that relies only on voltage for its determination. The combination of the holding of charge at the weakest cell, and transfer of charge to the weakest cells from stronger cells provides the ability to remove the weak cell while the battery is in operation for replacement of the weakest cell it with a new cell. Charge balancing between cells can be performed at any time during charge, standby, and discharge, and can be user provisioned, or turned on or off by the system as a result of changes in overall battery state.

In some examples, data associated with moving charge, such as cell voltage, temperature, and charge before and after movement, can be stored by the controller as primary data that can be used to derive secondary data such as additional data via algorithm for internal cell resistance, cell state of charge, cell state of health, and an approximate cell grade determination. All of the secondary data can also be timestamped, can be stored, and can be used to make determinations or recommendations, such as for replacement of one or more cells.

The above discussion is intended to provide an overview of subject matter of the present patent application. It is not intended to provide an exclusive or exhaustive explanation of the invention. The description below is included to provide further information about the present patent application.

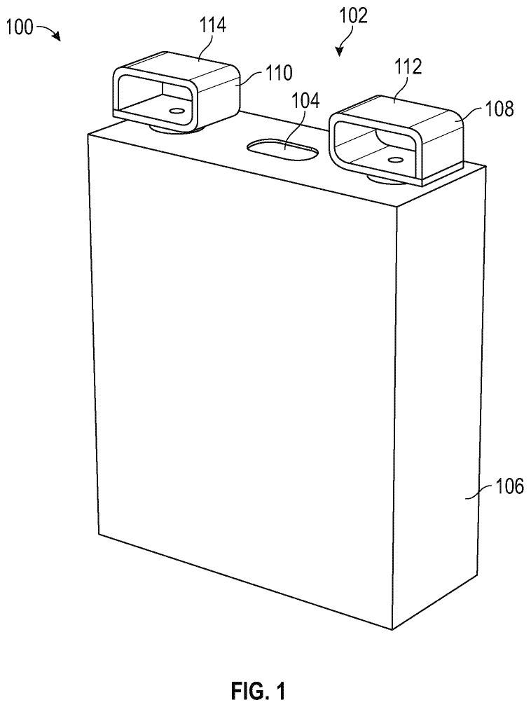

FIG. 1 illustrates an isometric view of a battery 102 (or a cell 102) of a battery system 100, which can be or can include an ACC such as one or more of a Lithium Ion battery, a Lithium Iron Phosphate battery, a Nickel Metal Hydride battery, a Lithium-Sulfur batter, a Sodium-Ion battery, a Lithium Nickel Manganese Cobalt Oxide battery, a thin film Lithium battery, a Sodium-Sulfur battery, or the like. The battery 102 can include a battery cell 104 that can be electrolytic or galvanic such that the battery cell 104 can include a negative cathode and a positive anode or can include a positive anode and a negative cathode located at least partially within the battery cell 104. The battery cell 104 (and the anode and cathode) can be at least partially surrounded by a casing 106 (or housing 106) of the battery 102.

Though the battery 102 is discussed as being a battery and a cell, the battery 102 can be or can include one or more cell, one or more battery, one or more battery module, one or more battery assembly, or one or more battery system. Similarly, battery cell 104 can be one or more batteries, one or more cells, one or more battery module, one or more battery assembly, or one or more battery system. Similarly, the battery system 100 can be or can include one or more cell, one or more battery, one or more battery module, one or more battery assembly, or one or more battery system.

The anode and the cathode of the battery cell 104 can be connected to a positive terminal 108 and a negative terminal 110. The positive terminal 108 and the negative terminal 110 can each extend through or above the casing 106 and the positive terminal 108 and the negative terminal 110 can be spaced apart from each other. Each of the positive terminal 108 and the negative terminal 110 can be conductors made of one or more of copper, aluminum, gold, silver, platinum, gold, iron, steel, brass, bronze, or the like. The positive terminal 108 can include a contact surface 112 that is relatively flat or planar. Similarly, the negative terminal 110 can include a contact surface 114 that is similarly flat or planar.

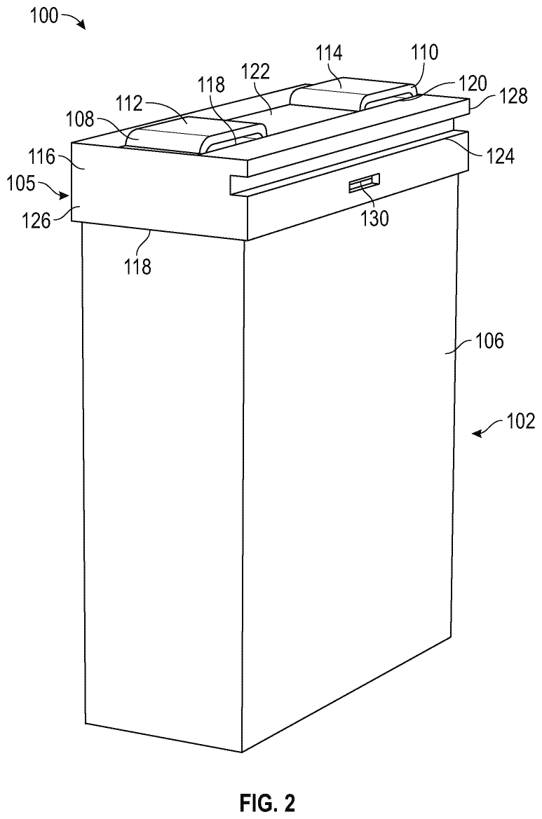

FIG. 2 illustrates an isometric view of a portion of the battery system 100. The battery system 100 can be consistent with FIG. 1 discussed above. FIG. 2 shows that the battery system 100 can include a cap 105.

The cap 105 can be a rigid or semi-rigid member made of materials such as one or more of metals, plastics, foams, elastomers, ceramics, composites, or the like. In some examples, the cap 105 can be made of one or more electrically insulative materials such as a polymer or plastic. The cap 105 can include a body 116 defining an opening 118 at a bottom portion thereof. The opening 118 can be configured to receive the battery 102 at least partially therein such that there is a relatively tight engagement between the casing 106 and the body 116 at the opening 118. The cap 105 can also include or define a terminal opening 118 and a terminal opening 120 that can be spaced apart from each other. Each of the opening 118 and the terminal opening 120 can extend through a top portion 122 or surface of the body 116 of the cap 105. The opening 118 can be configured to receive the positive terminal 108 of the battery cell at least partially therethrough and the terminal opening 120 can be configured to receive the negative terminal 110 at least partially therethrough, such that the contact surface 112 and the contact surface 114 can extend beyond the top portion 122 of the cap 105.

The cap 105 can also include a slot 124 extending between a front surface 126 (or front portion 126) of the cap 105 and a rear surface 128 (or rear portion 128) of the cap 105. The slot 124 can extend laterally inward into the body 116 from an outer lateral surface of the body 116 to form a slot, recess, dovetail, or the like. The slot 124 can be configured to interface with a rack to secure the battery cell to the rack, as discussed in further detail below.

The cap 105 can also include a fastener 130 that can extend laterally inward from a lateral side of the body 116 such as to engage the casing 106 to help to secure the cap 105 to the casing 106. The fastener 130 can be integrally formed into the body 116 or can be connected thereto. The fastener 130 can also include an opening that can provide access to the fastener 130 such as for using an instrument to help disengage the fastener 130 from the casing 106 to remove the cap 105 from the battery 102. The opening 130 can alternatively be or can include a vent for cell off-gassing.

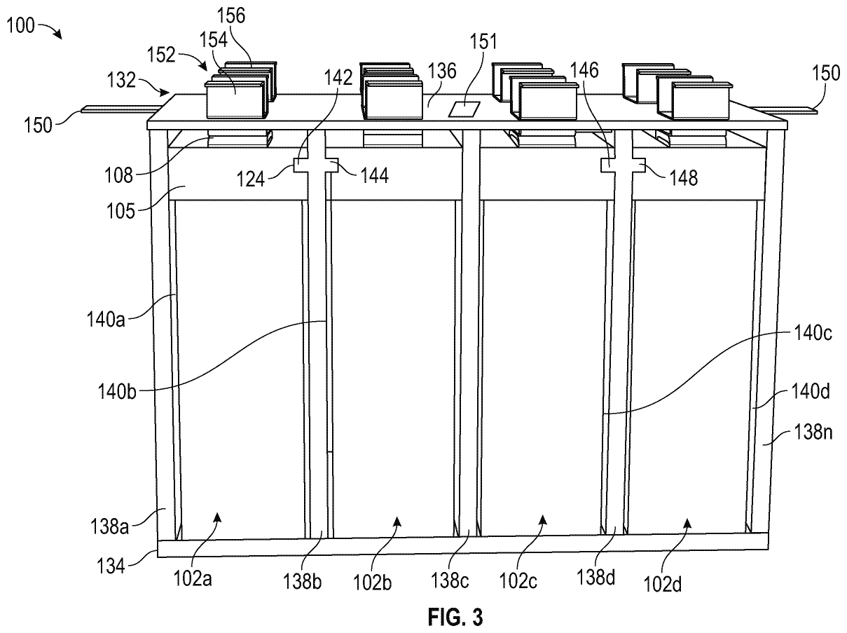

FIG. 3 illustrates an isometric view of a portion of the battery system 100. The battery system 100 can be consistent with FIGS. 1-2 discussed above. FIG. 3 shows that the battery system 100 can include a rack 132. The rack 132 can be configured to receive battery cells at least partially therein to secure the battery cells to the rack 132.

More specifically, the rack 132 can include a base 134 and a top support 136 that can be interconnected by walls 138a-138n (collectively referred to as the walls 138). The base 134, the top support 136, and the walls 138 can be rigid or semi-rigid members made of materials such as one or more of metals, plastics, foams, elastomers, ceramics, composites, or the like. In some examples, the base 134, the top support 136, and the walls 138 can be made of electrically insulative material(s) such as one or more plastics or polymers. In some examples, the base 134, the top support 136, and the walls 138 can include non-insulative materials (e.g., steel) that can be coated with one or more electrically insulative material such as an outer layer of polymer.

The walls 138, the base 134, and the top support 136 can together at least partially define openings 140a-140d, which can be openings, slots, or racks configured to receive battery cells 102 at least partially therein. That is, the opening 140a can receive the battery 102a at least partially therein, the opening 140b can receive the battery 102b at least partially therein, the opening 140c can receive the battery 102c at least partially therein, and the opening 140d can receive the battery 102d at least partially therein to secure the batteries 102 to the rack 132.

The wall 138b can include a rail 142 and a rail 144. The rail 142 can extend from the wall 138b toward the wall 138a, and the rail 144 can extend from the wall 138b toward the wall 138a. Similarly, the wall 138d can include a rail 146 and a rail 148. The rail 146 can extend from the wall 138d toward the wall 138c, and the rail 148 can extend from the wall 138d toward the wall 138n. The rails can be configured to support the batteries 102 within the rack 132 and can be configured to orient the batteries 102 such that the terminals of the batteries 102 properly align with terminals of the rack 132. For example, the rail 142 can engage with the slot 124 of the battery 102a to align the battery 102a in the opening 140a in a first direction, and the rail 144 can engage with the slot 124 of the battery 102b to align the battery 102b in the opening 140b in a second direction. This can allow the negative terminal of the battery 102a to be adjacent the positive terminal of the battery 102b so that a busbar 150 can more efficiently be routed through the rack and more easily connected to the terminals of the batteries 102 in a series configuration.

The busbar 150 can be one or more conductive strips or bars interconnectable to each other and connected to the top support 136. In some examples, the busbar 150 can be a relatively flat and flexible cable. The busbar 150 can be made of relatively thick individual bars to help reduce entropy. Relatively thicker bars can be used because the rack 132 is not replaced when each cell102 is replaced. The busbar 150 can be part of a power system 152 of the rack 132 that is configured to deliver power from the batteries 102. The busbar 150 can be electrically connectable to the positive terminal 108 and the negative terminal 110 of the battery cell 102a when the battery cell 102a is received within the rack 132. The busbar 150 can be configured to connect to each of the batteries 102 in a similar manner, connecting the batteries 102 in series. In some examples, the batteries 102 can each have a voltage between 3 volts and 3.3 volts to allow the power system 152 to deliver power from the busbar 150 and the power system 152 at 12 volts. 3.0 volts and 3.3 volts are mentioned in this disclosure as a reference to a particular type of battery cell with a particular chemistry. The actual voltage range may be different.

The battery system 100 can also include a controller 151 that can be connected to one or more of the power system 152 and the busbar 150 and can be configured to control (e.g., electrically) one or more components of the battery system 100, as discussed in further detail below. The controller 151 can be a programable controller, such as a single or multi-board computer, a direct digital controller (DDC), a programable logic controller (PLC), printed circuit board (PCB), or the like. In other examples the controller 151 can be any computing device, such as a handheld computer, for example, a smart phone, a tablet, a laptop, a desktop computer, or any other computing device including a processor, memory, and communication capabilities.

FIG. 3 also shows that the battery system 100 can include a rack positive terminal 154 and a rack negative terminal 156. The rack positive terminal 154 can be connected to the rack 132 and can be electrically connectable to the busbar 150 and the power system 152. The rack negative terminal 156 can also be connected to the rack 132 and electrically connectable to the busbar 150 and to the power system 152. The rack positive terminal 154 can be configured to interface with the positive terminal 108 of the battery cell 102a and the rack negative terminal 156 can be configured to interface with the negative terminal 110 of the battery cell to electrically connect the battery cell 102 to the power system 152. The batteries 102b-102d can also interface with terminals to electrically connect the batteries to the busbar 150 and the power system 152.

And, as referenced above, the rail 142 can be insertable into the slot 124 of the cap to orient the battery 102a such that the negative terminal 110 of the battery 102 engages the rack negative terminal 156 and such that the positive terminal 108 engages the rack positive terminal 154 when the battery 102a is inserted into the opening 140a of the rack 132.

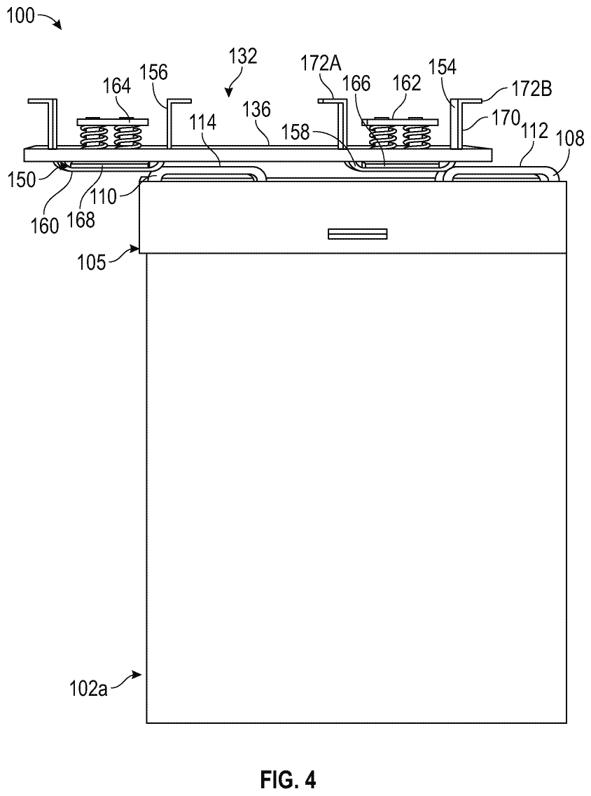

FIG. 4 illustrates an isometric view of a portion of the battery system 100. The battery system 100 can be consistent with FIGS. 1-3 discussed above. FIG. 4 shows how the batteries 102 can be automatically electrically connected to the busbar 150 during insertion of a battery into the rack 132, and how the batteries 102 can be automatically electrically disconnected from the busbar 150 during removal of a battery from the rack 132.

FIG. 4 more clearly shows how the top support 136 can at least partially support the rack positive terminal 154 such that a contact portion 158 of the rack positive terminal 154 extends at least partially below the top support 136. Similarly, the top support 136 can at least partially support the rack negative terminal 156 such that a contact portion 160 of the rack negative terminal 156 extends at least partially below the top support 136.

FIG. 4 also shows that the battery system 100 can include a positive biasing assembly 162 and a negative biasing assembly 164. The positive biasing assembly 162 can be connected to the rack 132, and the positive biasing assembly 162 can be connected to the rack positive terminal 154 such that the positive biasing assembly 162 can bias the rack positive terminal 154 away from a first busbar 166 of the busbar 150. The negative biasing assembly 164 can be connected to the rack 132, and the negative biasing assembly 164 can be connected to the rack negative terminal 156 such that the negative biasing assembly 164 can bias the rack negative terminal 156 away from a second busbar 168 of the busbar 150.

The first busbar 166 can be connected to the rack 132 and can be electrically connected to the power system 152 and the second busbar 168 can be connected to the rack 132 and can be electrically connected to the power system 152. The first busbar 166 and the second busbar 168 can each be a portion of the busbar 150 to which the battery 102a can connect (via the positive terminal 108 and the negative terminal 110) to electrically connect the battery 102a to the busbar 150 and therefore to the power system 152.

In operation of some examples, and as shown in FIG. 4, as the battery 102a is inserted into the opening 140a of the rack 132, the positive terminal 108 of the battery cell (and more specifically the contact surface 112) can engage the contact portion 158 of the rack positive terminal 154 to overcome a spring force applied to the rack positive terminal 154 by the positive biasing assembly 162 to cause the rack positive terminal 154 to engage the first busbar 166 to electrically connect the positive terminal 108 to the first busbar 166 and therefore to the busbar 150 and the power system 152. Similarly, the negative terminal 110 of the battery cell (the contact surface 114) can engage the contact portion 160 of the rack negative terminal 156 to overcome a spring force applied to the rack negative terminal 156 by the negative biasing assembly 164 to cause the rack negative terminal 156 to engage the second busbar 168 to electrically connect the negative terminal 110 to the second busbar 168 and therefore to the busbar 150 and the power system 152. In this way, the battery 102a can be automatically electrically connected to the busbar 150 and the power system 152 when the battery 102a is inserted into the opening 140a. And, because the rail 142 is inserted into the slot 124 to properly orient the battery 102a, the rack 132 helps to ensure the battery 102a is properly connected to the busbar 150 (e.g., the positive terminal 108 is connected to the rack positive terminal 154 and the negative terminal 110 is connected to the rack negative terminal 156).

Also, when the battery 102a is removed from the opening 140a, the negative biasing assembly 164 can apply a downward force on the rack negative terminal 156 to move the rack negative terminal 156 away from the top support 136 and away from the second busbar 168 so that the rack negative terminal 156 disconnects from the busbar 150. Similarly, the positive biasing assembly 162 can apply a downward force on the rack positive terminal 154 to move the rack positive terminal 154 away from the top support 136 and away from the first busbar 166 so that the rack positive terminal 154 disconnects from the busbar 150. In this way, the battery 102a can be automatically disconnected, electrically, from the busbar 150 and the power system 152 when the battery 102a is removed from the opening 140a.

As shown in FIG. 4, the positive terminal 108 and the negative terminal 110 can include fore and aft (or front and rear) portions that are curved, arced, or radiused. Similarly, the contact portion 158 and the contact portion 160 can include fore and aft (or front and rear) portions that are curved, arced, or radiused. This can allow for the positive terminal 108 and the negative terminal 110 to easily slide past or slide into engagement with the rack positive terminal 154 and the rack negative terminal 156 when the battery 102 is inserted into the rack 132.

FIG. 4 also shows that the rack positive terminal 154 can include a body 170 and arms 172a and 172b extending laterally away from the body 170. The arms 172a and 172b can be configured to engage the top support 136 when the battery 102a is removed to limit downward movement of the rack positive terminal 154 with respect to the top support 136. In other words, the rack positive terminal 154 can be captured by the top support 136 and the arms 172a and 172b. The arms 172 can also be used to make connections with other circuits or wires.

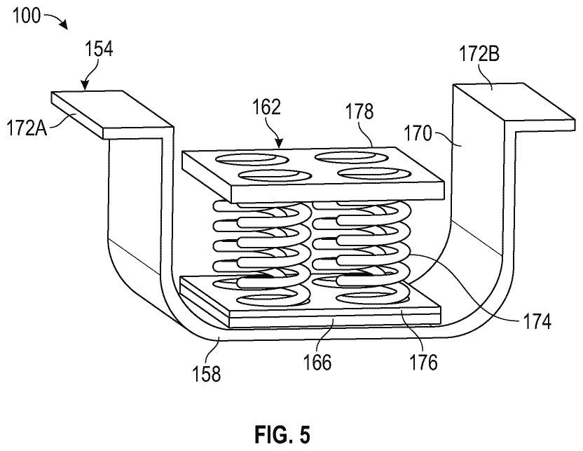

FIG. 5 illustrates an isometric view of a portion of the battery system 100. The battery system 100 can be consistent with FIGS. 1-4 discussed above. FIG. 5 shows how the rack terminals (e.g., the rack positive terminal 154) can be configured. For example, FIG. 5 shows that the positive biasing assembly 162 can include a plurality of biasing elements 174 and retainers 176 and 178.

Each of the elements 174 can be connected to the retainers 176 and 178. The retainer 176 can be connected to the rack positive terminal 154 such as to the body 170 and the retainer 178 can be connected to the top support 136 or another component of the rack 132 as discussed below. In some examples, the retainer 176 can extend through the first busbar 166 (or through a hole or bore in the first busbar 166) to allow the retainers 176 to directly contact the rack positive terminal 154 and to allow the positive biasing assembly 162 to bias the rack positive terminal 154 with respect to the rack 132. In other examples, the first busbar 166 can be connected to the retainers 176 and can be movable with the rack positive terminal 154 and the retainers 176 and the first busbar 166 can engage with other portions of the busbar 150 when the contact portion 158 is moved by the positive terminal 108. Though FIG. 5 shows that the positive biasing assembly 162 includes four springs, the positive biasing assembly 162 can include 1, 2, 3, 5, 6, 7, 8, 9, or 10 springs, or the like. Though FIG. 5 shows that the elements 174 can be coiled wire springs, the elements 174 can be any other type of spring including compression springs, extension springs, torsion springs, flat springs, helical springs, or the like.

FIG. 5 also shows that the first busbar 166 can be relatively flat and can have a flat surface that is parallel (or near parallel, or substantially parallel, such as within 5 degrees) with an inner surface of the body 170 to help ensure an affirmative or solid engagement or connection between the first busbar 166 and the rack positive terminal 154.

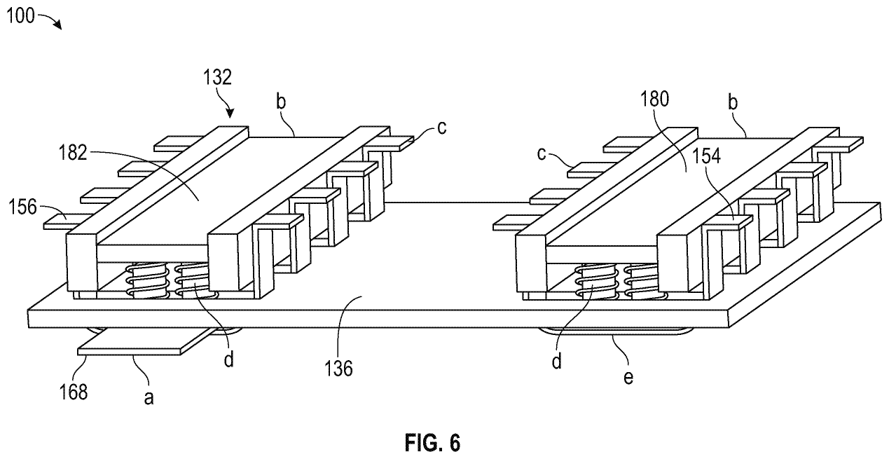

FIG. 6 illustrates an isometric view of a portion of the battery system 100. The battery system 100 can be consistent with FIGS. 1-5 discussed above. FIG. 6 shows how the rack terminals (e.g., the rack positive terminal 154) can be secured to the rack 132. For example, FIG. 6 shows that rack 132 can include a first beam 180 and a second beam 182.

The first beam 180 can be connected to or supported by the top support 136 or another component of the rack 132. Similarly, the second beam 182 can be connected to or supported by the top support 136 or another component of the rack 132. The beams 180 and 182 can be configured to engage the top retainer 178 of each of the biasing assemblies. For example, the second beam 182 can engage the retainer 178 of the negative biasing assembly 164 to bias the rack negative terminal 156 away from the second beam 182 and the top support 136, and the first beam 180 can engage the retainers 178 of the positive biasing assembly 162 to bias the rack positive terminal 154 away from the second beam 182 and the top support 136.

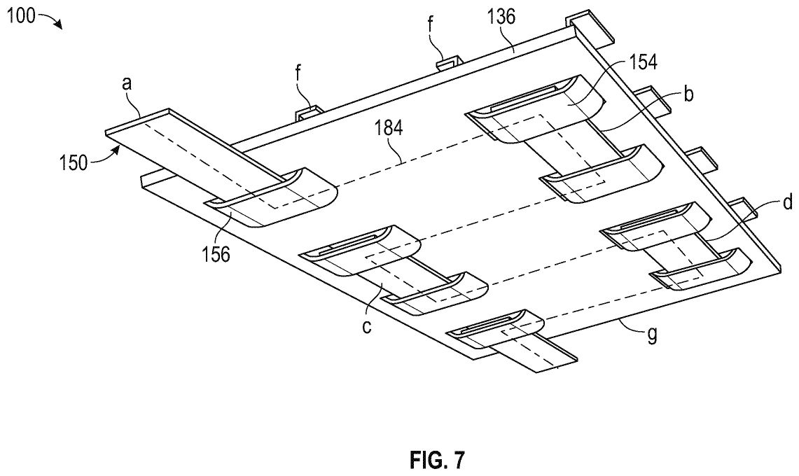

FIG. 7 illustrates an isometric view of a portion of a battery system. The battery system 100 can be consistent with FIGS. 1-6 discussed above. FIG. 7 shows how the rack terminals (e.g., the rack positive terminal 154) can engage the busbar 150.

For example, FIG. 7 shows that when the rack terminals (e.g., the rack positive terminal 154 and the rack negative terminal 156) are moved upward by the battery terminals (as shown in FIG. 4), the batteries 102, the rack terminals and the busbar 150 can form a circuit 184, which can be a power circuit that is part of the power system 152.

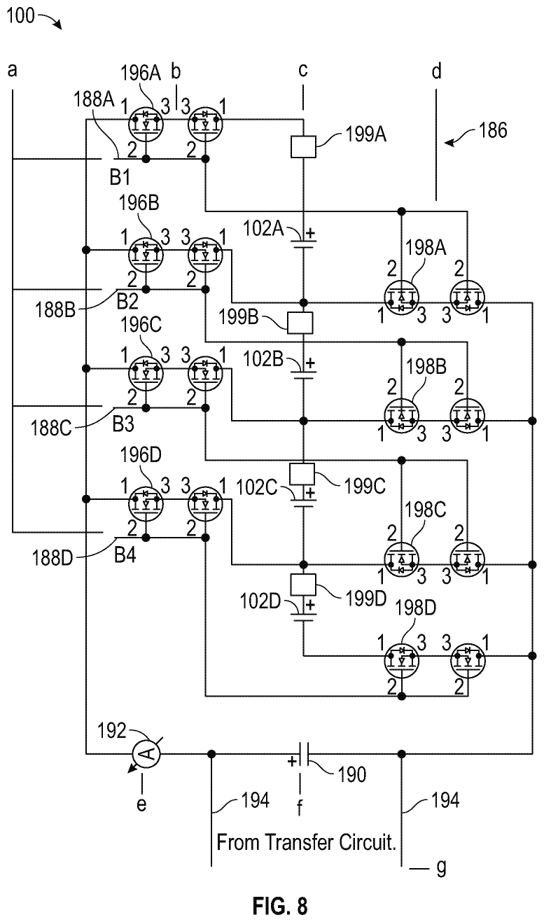

FIG. 8 illustrates a schematic view of a charge hold circuit 186 of the battery system 100. The battery system 100 can be consistent with FIGS. 1-7 discussed above. FIG. 8 shows that the charge hold circuit 186 can include transfer inputs 188A, 188B, 188C, and 188D. Each of the inputs 188 can be a connection connectable to a transfer circuit (discussed below). The charge hold circuit 186 can also include an ammeter 192 connected to the charge hold capacitor 190 and can include a transfer circuit connection 194 connected to the charge hold capacitor 190.

The charge hold circuit 186 can also include high side switches 196A, 196B, 196C, and 196D connected to the batteries 102A, 102B, 102C, and 102D, respectively. The charge hold circuit 186 can also include low side switches 198A, 198B, 198C, and 198D connected to the batteries 102A, 102B, 102C, and 102D, respectively. The charge hold circuit 186 can also include sensors 199A, 199B, 199C, and 199D that can be connected to the batteries 102A, 102B, 102C, and 102D, respectively.

The capacitor 190 can be a capacitor such as a supercapacitor or ultracapacitor. The capacitor 190 may be a multiplicity of capacitors in parallel, series or both. The capacitor 190 can be or can include an ACC such as one or more of a Lithium Ion battery, a Lithium Iron Phosphate battery, a Nickel Metal Hydride battery, a Lithium-Sulfur batter, a Sodium-Ion battery, a Lithium Nickel Manganese Cobalt Oxide battery, a thin film Lithium battery, a Sodium-Sulfur battery, or the like. The capacitor 190 can have a voltage between 3 volts and 3.3 volts to allow the capacitor 190 to operate as a substitute for any of the cells 102. In an example where the cells 102 have a different voltage, the capacitor 190 can have the same voltage as the cells 102 (e.g., 5 or 10 volts).

Each of the high side switches 196 can be an electrically controllable switch, such as a metal-oxide-semiconductor field-effect transistor (MOSFET) switch, junction-gate field-effect transistor (JFET), other field-effector transistor (FET) switch, or the like. Similarly, each of the low side switches 198 can be a MOSFET switch, a JFET switch, other FET switch, or the like. The sources of the switches 196 and 198 can be connected to the batteries 102 and the gates of the high side switches 196 and the low side switches 198 can be connected to each other and to the inputs 188. The gates can be biased by the voltage at the corresponding input 188. For example, the battery 102A can be selected by biasing the gates of the high side switches 196A via the input 188A. A gate driver can supply an appropriate bias voltage to the inputs 188 to turn each of the high side switches 196 and the low side switches 198 on or off.

The ammeter 192 can be connected to the capacitor 190 and can be configured to generate a signal based on an amperage, amperes, or current from, current of, or current to the capacitor 190. The signal can be transmitted to a controller (such as the controller 151) and can be used to control one or more components of the power system 152 or the battery system 100, as discussed in further detail below. The ammeter 192 can be any analog (e.g., with an analog to digital converter) or digital ammeter such as a Hall effect ammeter, moving coil ammeter, electrodynamic ammeter, moving-iron ammeter, hot wire ammeter, integrating ammeter, or the like.

The sensors 199 can each be a sensor connected to one of the batteries 102 and configured to generate a signal (such as for transmission to the controller) based on one or more characteristics of the respective battery 102 to which the sensor 199 is connected. For example, the sensors 199 can be a voltage sensor, a current sensor, an inductance sensor, a Hall effect sensor, or the like. The signals generated by the sensors 199 can be indicative of a voltage, current, capacitance, inductance, or other characteristic of or around the batteries 102.

In operation of some examples, the charge hold circuit 186 can be connected to the power system 152 and connected to the controller 151 to allow the controller 151 to control the charge hold circuit 186 to selectively connect the capacitor 190 to one of the battery cells 102A-102D. As discussed in further detail below, the controller 151 can receive signals from the sensors 199 and can use the signals to determine a characteristic of the batteries 102, such as a voltage or potential of each of the batteries 102. The controller 151 can then determine which of the batteries 102 has a lowest potential of the batteries 102, and the controller 151 can operate the high side switches 196 and the low side switches 198 to connect the capacitor 190 to the cell 102 that has the lowest potential. By doing this, the controller 151 can place the capacitor 190 across or the cell 102 with the lowest voltage to allow the battery 102 with the lowest voltage to be replaced without reducing an overall voltage of the power system 152. In other words, the capacitor 190 can operate as an instant substitute for a cell 102 that is being replaced, allowing for hot-swapping of individual battery cells.

And, such an operation can be continuously performed so that the capacitor 190 is relocated to whichever cell has the lowest potential. So, for example, if battery 102a is the lowest, the capacitor 190 can be connected across the capacitor 190 by the high side switches 196a and the low side switches 198a. The battery 102a can then be removed from the rack 132 and can be disconnected automatically (as discussed above), allowing the capacitor 190 to maintain an overall voltage of the power system 152. Then, a new battery can be inserted into the opening 140a to become the new battery 102a. At this point, the controller 151 can then determine which battery has the lowest voltage (based on the signals from the sensors 199) and the controller 151 can keep the capacitor 190 connected to the battery 102a if the voltage of the battery 102a is still the lowest. Alternatively, when the controller 151 determines another cell (e.g., one of the batteries 102b-102d) has the lowest voltage, the controller 151 can disconnect the capacitor 190 from the battery 102a and move it to the new cell with the lowest voltage (e.g., the battery 102b). In this way, the capacitor 190 can be moved between cells to allow for one or more batteries to be hot-swapped while the power system 152 provides power at a consistent voltage.

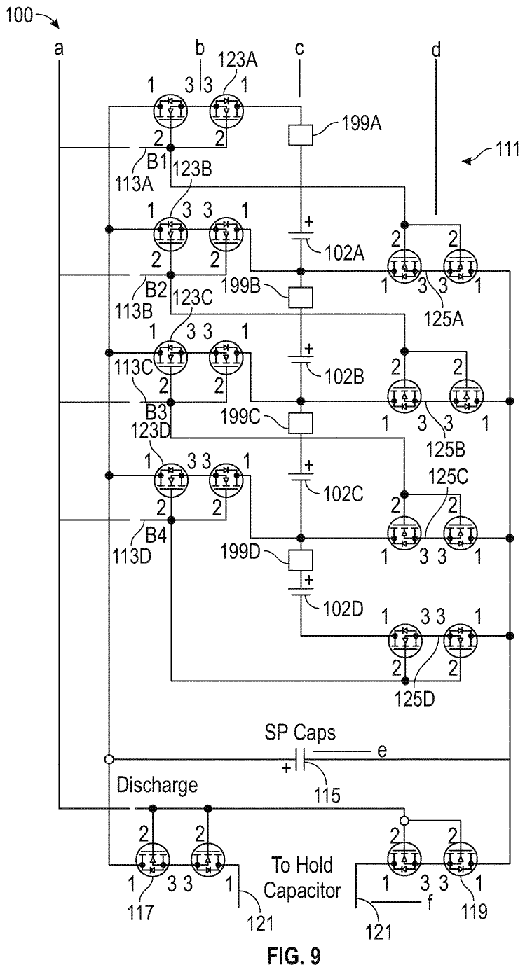

FIG. 9 illustrates a schematic view of a charge transfer circuit 111 of the battery system 100. The battery system 100 can be consistent with FIGS. 1-8 discussed above.

FIG. 9 shows that the charge transfer circuit 111 can include hold inputs 113A, 113B, 113C, and 113D. Each of the inputs 113 can be a connection selectively connectable to the charge hold circuit 186 such as connected to the inputs 188A, 188B, 188C, and 188D, respectively. The sensors 199 can be similar to or the same as the sensors 199 of FIG. 8 and can be connected to the batteries 102, respectively.

The charge transfer circuit 111 can also include a charge transfer capacitor 115 connected to switches 117 and 119. The capacitor 115 (and the switches 117 and 119) can also be connected to the charge hold circuit 186 such as via hold circuit connections 121. The charge transfer circuit 111 can include high side switches 123A, 123B, 123C, and 123D (collectively referred to as high side switches 123) connected to the batteries 102A, 102B, 102C, and 102D, respectively. The charge hold circuit 186 can also include low side switches 125A, 125B, 125C, and 125D (collectively referred to as low side switches 125) connected to the batteries 102A, 102B, 102C, and 102D, respectively. The charge transfer circuit 111 can also include the sensors 199A, 199B, 199C, and 199D that can be connected to the batteries 102A, 102B, 102C, and 102D, respectively.

The capacitor 115 can be a capacitor such as a supercapacitor or ultracapacitor. The capacitor 115 a Lithium Iron Phosphate battery, can be or can include an ACC such as one or more of a Lithium Ion battery, a Nickel Metal Hydride battery, a Lithium-Sulfur batter, a Sodium-Ion battery, a Lithium Nickel Manganese Cobalt Oxide battery, a thin film Lithium battery, a Sodium-Sulfur battery, or the like. The capacitor 115 can have a voltage between 3 volts and 3.3 volts to allow the capacitor 115 to transfer power between the batteries 102. In an example where the batteries 102 have a different voltage, the capacitor 115 can have the same voltage as the batteries 102 (e.g., 5 or 10 volts).

Each of the high side switches 123, the low side switches 125, and the switches 117 and 119 can be a MOSFET switch, a JFET switch, other FET switch, or the like. The sources of the switches 123 and 125 can be connected to the batteries 102 and the gates of the high side switches 123 and the low side switches 125 can be connected to each other and to the inputs 188. The gates can be biased by the voltage at the corresponding lead. A gate driver can supply an appropriate bias voltage to the leads to turn each of the high side switches 123 and the low side switches 125 on or off.

In operation of some examples, the charge transfer circuit 111 can be connected to the power system 152 and can be connected to a controller 151 to allow the controller 151 to control the charge transfer circuit 111 to selectively connect the capacitor 115 to one of the plurality of battery cells 102A-102D. As discussed in further detail below, the controller 151 can receive signals from the sensors 199 and can use the signals to determine a characteristic of the batteries 102, such as a voltage or potential of each of the batteries 102. The controller 151 can determine which of the batteries 102 has a lowest potential and which of the batteries 102 has the highest potential.

The controller 151 can then operate the high side switches 123 and the low side switches 125 to connect the capacitor 115 to the battery 102 that has the highest potential to allow transfer of power from the highest charge battery 102 to the capacitor 115. Once the capacitor 115 is charged fully or when the characteristic (e.g., voltage) of the highest charged battery 102 falls below a threshold value, the capacitor 115 can be disconnected from the highest charge battery and then connected to the battery 102 with the lowest charge to transfer charge from the capacitor 115 to the battery 102 with the lowest charge. This can be done by operating the high side switches 123 and the low side switches 125 to connect the lowest charge battery 102 to the capacitor 115 to transfer charge from the capacitor 115 to the battery 102 with the lowest charge. Or, this can be done by operating the switches 117 and the switches 119 to connect the capacitor 115 to the capacitor 190 via the hold circuit connections 121 and the transfer circuit connections 194. Once the capacitor 115 is connected to the capacitor 190, charge can be transferred from the capacitor 115 to the capacitor 190 and therefore to the cell with the lowest charge (to which the capacitor 190 is connected). Or, charge can be transferred directly from the capacitor 115 to the battery 102 with the lowest charge.

The controller 151 can also be used to determine the state of charge state of each of the batteries 102, determine the state of health of each of the batteries 102, self-calibrate the state of charge by voltage measurement by using a measurement of charge transferred, and can determine if a degraded one of the batteries 102 is a candidate for a “B” grade usage according to UL 1974. All data received or stored by the controller 151 including the data discussed above, can be available for, and all user parameters can be provisional from REST requests to the battery. These REST services can be requested through any standardized communications protocols such as USB, NFC, Bluetooth, Ethernet, WiFi, or the like.

In some examples, one or more sensors 199 can include a temperature sensor, such as a solid state thermistor that can be placed at the back of each cell cavity in the battery. The temperature sensor can transmit temperature data for each cell to the controller which can use the controller 151, which can determine a temperature of each cell and can use the temperature information to make one or more determinations or recommendations of the cell or cells, such as replacement, movement of charge, etc.

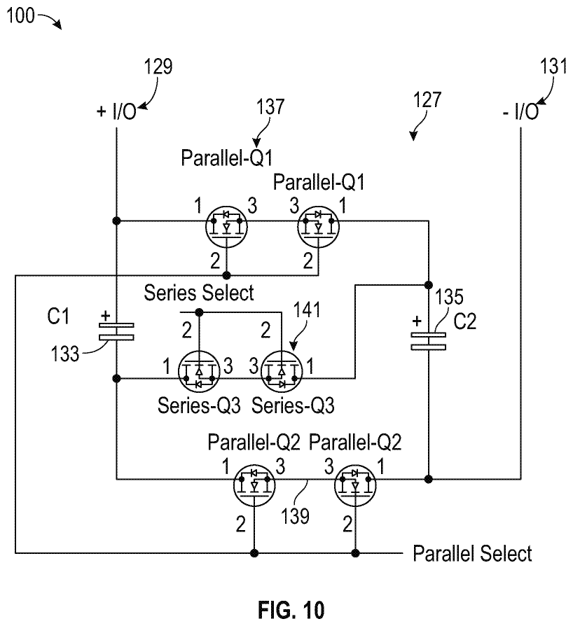

FIG. 10 illustrates a schematic view of a switching circuit 127 of the battery system 100. The battery system 100 can be consistent with FIGS. 1-9 discussed above. FIG. 10 shows that the switching circuit 127 can include connections 129 and 131 to the transfer circuit 111 high and low rails to allow the switching circuit 127 to operate as a capacitor equivalent. In some examples, the switching circuit 127 can be a substitute for the capacitor 115.

The switching circuit 127 can also include capacitors 133 and 135, which can each be a capacitor such as a supercapacitor or ultracapacitor. The capacitors 133 and 135 can be or can include an ACC such as one or more of a Lithium Ion battery, a Lithium Iron Phosphate battery, a Nickel Metal Hydride battery, a Lithium-Sulfur batter, a Sodium-Ion battery, a Lithium Nickel Manganese Cobalt Oxide battery, a thin film Lithium battery, a Sodium-Sulfur battery, or the like. The capacitors 133 and 135 can have a voltage between 3 volts and 3.3 volts to allow the capacitors 133 and 135 to transfer power between or to the batteries 102. In an example where the batteries 102 have a different voltage, the capacitors 133 and 135 can have the same voltage as the batteries 102 (e.g., 5 or 10 volts). The capacitors 133 and 135 can also be the capacitors 115 and 190.

The switching circuit 127 can also include switches 137, switches 139, and switches 141, which can be a MOSFET switch, a JFET switch, other FET switch, or the like. The switches 137, switches 139, and switches 141 can be controlled (such as by the controller 151) to connect the capacitors 133 and 135 in series or in parallel. By controlling whether the switching circuit 127 is in series mode or in parallel mode, the switching circuit 127 can control whether the capacitors 133 and the capacitors 135 are connected in series or parallel to each other and to another cell or cells of the power system 152 (e.g., the batteries 102).

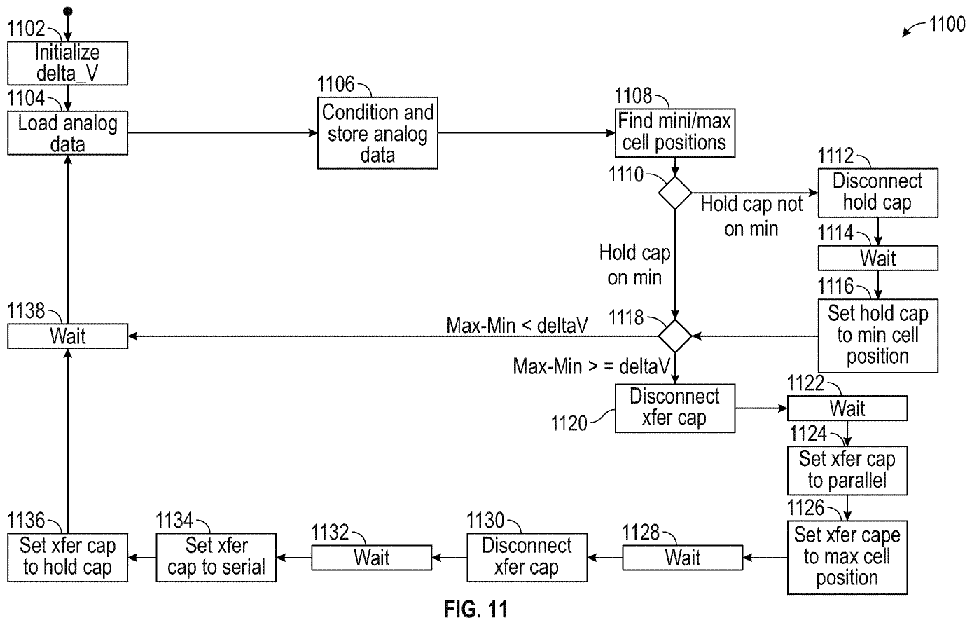

FIG. 11 illustrates a schematic view of a method or use of a battery system. The method 1100 can be a method of operating or controlling the battery system 100. More specific examples of the method 1100 are discussed below. The steps or operations of the method 1100 are illustrated in a particular order for convenience and clarity; many of the discussed operations can be performed in a different sequence or in parallel without materially impacting other operations. The method 1100 as discussed includes operations performed by multiple different actors, devices, or systems. It is understood that subsets of the operations discussed in the method 1100 can be attributable to a single actor, device, or system could be considered a separate standalone process or method.

The method 1100 can begin at a step 1102 where the method 1100 can be initialized, such as during startup of the battery system 100 (or reset or the like). At step 1104, a controller can receive a plurality of signals respectively from a plurality of sensors respectively connected to a plurality of battery cells connected to a rack of a battery system. For example, the controller 151 can receive a plurality of signals respectively from the plurality of sensors 199 respectively connected to the plurality of battery cells 102 connected to the rack 132 of the battery system 100. At step 1106, the controller 151 can store any of the data from the signals. Additionally, the controller 151 can control data, inputs, outputs, determinations, or calculations of any of the steps discussed below.

At step 1108, it can be determined which of the plurality of battery cells has a low charge (or low current or low voltage) and it can be determined which of the plurality of battery cells has a high charge (or high current or high voltage). For example, the controller 151 can use one or more of the signals from the sensors 199 to determine which of the batteries 102 has a low charge and which of the batteries 102 has a high charge. Optionally, the controller 151 can label the one of the plurality of battery cells that has a low charge as a low cell and can label the one of the plurality of battery cells that has a high charge as a high cell.

At step 1110, it can be determined whether the hold capacitor is connected to the minimum or low cell. To do this, the controller 151 can determine to which of the batteries 102 the capacitor 190 is connected. When it is determined that the capacitor 190 is not connected to the low cell, step 1112 can be performed where the controller 151 can operate the high side switches 196 and low side switches 198 to disconnect the capacitor 190 from the battery cell to which it is connected. At step 1114, a pause step can be performed, which can help prevent discharge or shorting of any circuits. At step 1116, the controller 151 can operate the high side switches 196 and low side switches 198 to the capacitor 190 to the low cell, such as in a parallel configuration or arrangement. This can allow the low cell to be disconnected from the rack 132 without reducing a voltage of the battery system 100 or the power system 152.

Following step 1116 or when it is determined at step 1110 that the capacitor 190 is already connected to the low cell, a step 1118 can be performed where the controller can calculate a voltage difference between the high cell and the low cell. For example, the controller can receive signals from the sensors 199A and 199D and determine that the battery 102A is the low cell with a voltage of 2.8 volts and the battery 102D is the high cell with a voltage of 3.1 volts. The controller 151 can then determine that a difference between the high cell and the low cell is 0.3 volts. If the difference is greater than a threshold voltage (deltaV), such as 0.05 volts, 0.1 volts, 0.2 volts, 0.3 volts, or the like, a series of steps to transfer charge can be performed. If the difference is less than the threshold voltage, the transfer steps can be skipped before the wait step 1138 can be performed and the method can begin again at the steps 1102 or 1104.

When the threshold is met, the step 1120 can be performed where the controller 151 can operate the high side switches 123 and the low side switches 125 to disconnect the capacitor 115 from any of the batteries 102. At step 1122 a wait step can be performed following disconnection of the capacitor 115. Then, at the step 1124, the switching circuit 127 can be operated by the controller to set the capacitor 115 to a parallel arrangement or configuration. At step 1126, the controller can operate the switches to connect the capacitor 115 to the high cell or max cell position in the parallel configuration or arrangement before another wait step 1128 is performed.

At step 1130, the capacitor 115 can be disconnected from the high cell or max cell before another wait step is performed. After the wait step 1132, a step 1134 can be performed where the switching circuit 127 can be operated by the controller to set the capacitor 115 to a series arrangement or configuration. At step 1136 the capacitor 115 can be connected to the capacitor 190 to allow the capacitor 115 to provide a charge to the capacitor 190 to help to balance a charge in the power system 152 and among the batteries 102. These steps or sequences can help to maintain an even charge throughout the batteries 102 and can help to improve battery health and life. The steps can also provide the system with information about the health of each of the cells which can be useful for planning cell switching. For example, as discussed above, the hold capacitor 190 can be placed across the lowest battery cell 102 in anticipation of replacement.

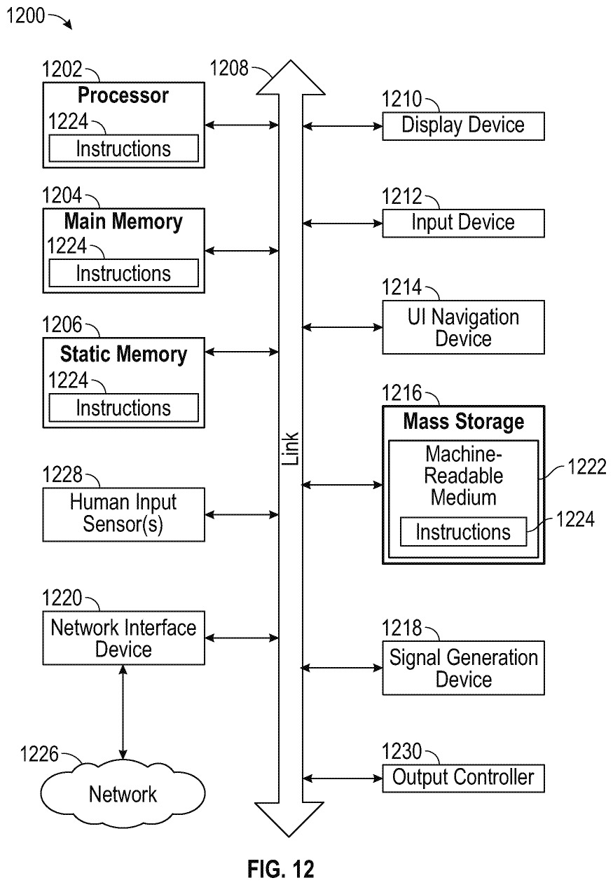

FIG. 12 illustrates a block diagram of an example machine 1200 upon which any one or more of the techniques (e.g., methodologies) discussed herein may perform. Examples, as described herein, may include, or may operate by, logic or a number of components, or mechanisms in the machine 1200. Circuitry (e.g., processing circuitry) is a collection of circuits implemented in tangible entities of the machine 1200 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1200 follow.

In alternative embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in peer-to-peer (P2P) (or other distributed) network environment. The machine 1200 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1200 may include a hardware processor 1202 (e.g., a central processing unit (CPU), a graphics processing unit (GPU), a hardware processor core, or any combination thereof), a main memory 1204, a static memory (e.g., memory or storage for firmware, microcode, a basic-input-output (BIOS), unified extensible firmware interface (UEFI), etc.) 1206, and mass storage 1208 (e.g., hard drive, tape drive, flash storage, or other block devices) some or all of which may communicate with each other via an interlink (e.g., bus) 1230. The machine 1200 may further include a display unit 1210, an alphanumeric input device 1212 (e.g., a keyboard), and a user interface (UI) navigation device 1214 (e.g., a mouse). In an example, the display unit 1210, input device 1212 and UI navigation device 1214 may be a touch screen display. The machine 1200 may additionally include a storage device (e.g., drive unit) 1208, a signal generation device 1218 (e.g., a speaker), a network interface device 1220, and one or more sensors 1216, such as a global positioning system (GPS) sensor, compass, accelerometer, or other sensor. The machine 1200 may include an output controller 1228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1202, the main memory 1204, the static memory 1206, or the mass storage 1208 may be, or include, a machine readable medium 1222 on which is stored one or more sets of data structures or instructions 1224 (e.g., software) embodying or utilized by any one or more of the techniques or functions described herein. The instructions 1224 may also reside, completely or at least partially, within any of registers of the processor 1202, the main memory 1204, the static memory 1206, or the mass storage 1208 during execution thereof by the machine 1200. In an example, one or any combination of the hardware processor 1202, the main memory 1204, the static memory 1206, or the mass storage 1208 may constitute the machine readable media 1222. While the machine readable medium 1222 is illustrated as a single medium, the term “machine readable medium” may include a single medium or multiple media (e.g., a centralized or distributed database, and/or associated caches and servers) configured to store the one or more instructions 1224.

The term “machine readable medium” may include any medium that is capable of storing, encoding, or carrying instructions for execution by the machine 1200 and that cause the machine 1200 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1224 may be further transmitted or received over a communications network 1226 using a transmission medium via the network interface device 1220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1220 may include one or more physical jacks (e.g., Ethernet, coaxial, or phone jacks) or one or more antennas to connect to the communications network 1226. In an example, the network interface device 1220 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1200, and includes digital or analog communications signals or other intangible medium to facilitate communication of such software. A transmission medium is a machine readable medium.

### NOTES AND EXAMPLES

The following, non-limiting examples, detail certain aspects of the present subject matter to solve the challenges and provide the benefits discussed herein, among others.

Example 1 is a multi-cell battery system comprising: a cap securable to a battery, the cap configured to receive a positive terminal and a negative terminal of the battery at least partially therethrough; a rack configured to receive the cap secured to the battery to secure the battery to the rack; and a power system connected to the rack and electrically connectable to the positive terminal and the negative terminal of the battery when the battery is received within the rack, the power system configured to deliver electrical power from the battery.

In Example 2, the subject matter of Example 1 optionally includes wherein the rack is configured to receive a plurality of batteries respectively connected to a plurality of caps to connect the plurality of batteries to the power system.

In Example 3, the subject matter of Example 2 optionally includes wherein each of the plurality of batteries is a 3-volt power cell connected in series to each other by the power system to allow the power system to deliver power at 12-volts.

In Example 4, the subject matter of any one or more of Examples 1-3 optionally include wherein the cap includes a first opening and a second opening spaced apart from each other and extending through a top surface of the cap, the first opening configured to receive the positive terminal of the battery at least partially therethrough, and the second opening configured to receive the negative terminal of the battery at least partially therethrough.

In Example 5, the subject matter of Example 4 optionally includes wherein the cap includes a slot extending between a front surface of the cap and a rear surface of the cap, the slot configured to interface with the rack to secure the battery to the rack.

In Example 6, the subject matter of Example 5 optionally includes wherein the rack includes a first wall and a second wall opposite the first wall, the first wall and the second wall together at least partially forming an opening configured to receive the battery at least partially therein to secure the battery to the rack.

In Example 7, the subject matter of Example 6 optionally includes wherein the rack includes a rail extending from the first wall toward the second wall, the rail insertable into the slot of the cap to secure the battery to the rack.

In Example 8, the subject matter of Example 7 optionally includes a rack positive terminal connected to the rack and electrically connected to the power system, the rack positive terminal configured to interface with the positive terminal of the battery; and a rack negative terminal connected to the rack and electrically connected to the power system, the rack negative terminal configured to interface with the negative terminal of the battery electrically to connect the battery to the power system.

In Example 9, the subject matter of Example 8 optionally includes wherein the rail is insertable into the slot of the cap to orient the battery such that the negative terminal of the battery engages the rack negative terminal and the positive terminal of the battery engages the rack positive terminal when the battery is inserted into the opening of the rack.

In Example 10, the subject matter of any one or more of Examples 8-9 optionally include a first busbar connected to the rack and electrically connected to the power system, the rack positive terminal engageable with the first busbar to electrically connect the positive terminal of the battery to the first busbar; and a second busbar connected to the rack and electrically connected to the power system, the rack negative terminal engageable with the second busbar to electrically connect the negative terminal of the battery to the second busbar.

In Example 11, the subject matter of Example 10 optionally includes a positive biasing element connected to the rack and to the rack positive terminal, the positive biasing element configured to bias the rack positive terminal away from the first busbar; and a negative biasing element connected to the rack and to the rack negative terminal, the negative biasing element configured to bias the rack negative terminal away from the second busbar.

In Example 12, the subject matter of Example 11 optionally includes wherein the positive terminal of the battery is engageable with the rack positive terminal to overcome the positive biasing element to cause the rack positive terminal to engage the first busbar, and wherein the negative terminal of the battery is engageable with the rack negative terminal to overcome the negative biasing element to cause the rack negative terminal to engage the second busbar to electrically connect the battery to the power system.

Example 13 is a multi-cell battery system comprising: a plurality of caps securable to a plurality of batteries, respectively, each of the plurality of caps configured to receive a positive terminal and a negative terminal, of one battery of the plurality of batteries, at least partially therethrough; a rack configured to receive the plurality of caps secured to respective ones of the plurality of batteries to secure the plurality of batteries to the rack; and a power circuit connected to the rack and electrically connectable to the positive terminal and the negative terminal of each of the plurality of batteries when the plurality of batteries are received within the rack, the power circuit configured to deliver electrical power from the plurality of batteries.

In Example 14, the subject matter of Example 13 optionally includes a plurality of rack positive terminals connected to the rack and electrically connected to the power circuit, the plurality of rack positive terminals configured to interface with respective ones of the positive terminal of the plurality of batteries; and a plurality of rack negative terminals connected to the rack and electrically connected to the power circuit, the plurality of rack negative terminals configured to interface with respective ones of the negative terminal of the plurality of batteries to electrically connect the plurality of batteries to the power circuit.

In Example 15, the subject matter of Example 14 optionally includes a controller connected to the power circuit and configured to selectively deliver power from the plurality of batteries.

In Example 16, the subject matter of Example 15 optionally includes a charge hold circuit connected to the power circuit and connected to the controller, the charge hold circuit including a hold capacitor, the controller configured to selectively connect the hold capacitor to one of the plurality of batteries.

In Example 17, the subject matter of Example 16 optionally includes a plurality of sensors connected to respective ones of the plurality of batteries, each of the plurality of sensors configured to generate a sensor signal based on a charge characteristic of the respective one of the plurality of batteries.

In Example 18, the subject matter of Example 17 optionally includes wherein the controller is configured to determine the charge characteristic of each of the plurality of batteries based on the sensor signal.

In Example 19, the subject matter of Example 18 optionally includes wherein the controller is configured to determine which of the plurality of batteries has a low charge.

In Example 20, the subject matter of Example 19 optionally includes wherein the controller is configured to connect the hold capacitor to the one of the plurality of batteries that has the low charge.

In Example 21, the subject matter of Example 20 optionally includes a charge balance circuit connected to the power circuit and connected to the controller, the charge balance circuit including a balance capacitor, the controller configured to selectively connect the balance capacitor to one of the plurality of batteries.

In Example 22, the subject matter of Example 21 optionally includes wherein the controller is configured to connect the balance capacitor to the one of the plurality of batteries that has the low charge.

In Example 23, the subject matter of any one or more of Examples 21-22 optionally include wherein the controller is configured to connect the balance capacitor to the hold capacitor to deliver charge to the hold capacitor.

In Example 24, the subject matter of any one or more of Examples 20-23 optionally include wherein the hold capacitor is connected in parallel to the one of the plurality of batteries that has the low charge.

In Example 25, the subject matter of any one or more of Examples 20-24 optionally include wherein the hold capacitor is configured to deliver charge to the power circuit when the one of the plurality of batteries that has the low charge is removed from the rack.

In Example 26, the subject matter of Example 25 optionally includes a busbar connected to the rack and electrically connected to the power circuit, the plurality of rack positive terminals and the plurality of rack negative terminals engageable with the busbar to electrically connect the plurality of rack positive terminals and the plurality of rack negative terminals to the busbar.

In Example 27, the subject matter of Example 26 optionally includes a plurality of positive biasing elements connected to the rack and to the plurality of rack positive terminals, respectively, the plurality of positive biasing elements each configured to bias the plurality of rack positive terminals, respectively, away from the busbar; and a plurality of negative biasing elements connected to the rack and to the plurality of rack negative terminals, respectively, the plurality of negative biasing elements each configured to bias the plurality of rack negative terminals, respectively, away from the busbar.

Example 28 is a non-transitory machine-readable medium including instructions, for controlling charge of a battery system, which when executed by a machine, cause the machine to: receive a plurality of signals respectively from a plurality of sensors respectively connected to a plurality of batteries connected to a rack of a battery system; determine which of the plurality of batteries has a low charge; determine which of the plurality of batteries has a high charge; label the one of the plurality of batteries that has a low charge as a low cell and label the one of the plurality of batteries that has a high charge as a high cell; determine to which of the plurality of batteries a charge hold capacitor is connected; connect the charge hold capacitor to the low cell in parallel to allow the low cell to be disconnected from the rack without reducing a voltage of the battery system.

In Example 29, the subject matter of Example 28 optionally includes wherein the plurality of signals are indicative of one or more charge characteristic of respective ones of the plurality of batteries.

In Example 30, the subject matter of any one or more of Examples 28-29 optionally include the instructions to further cause the machine to: determine whether a difference in voltage between the low cell and the high cell is greater than a threshold voltage; disconnect a charge transfer capacitor from the plurality of batteries; set the charge transfer capacitor to a parallel circuit configuration; connect a charge transfer capacitor in parallel to the high cell; disconnect the charge transfer capacitor from the high cell; change the charge transfer capacitor to a series circuit configuration; connect the charge transfer capacitor in series to the charge hold capacitor to connect the charge transfer capacitor to the low cell to balance a charge of the battery system.

Example 31 is a multi-cell battery system comprising: a cap securable to a cell, the cap configured to receive a positive terminal and a negative terminal of the cell at least partially therethrough; a rack configured to receive the cap secured to the cell to secure the cell to the rack; and a power system connected to the rack and electrically connectable to the positive terminal and the negative terminal of the cell when the cell is received within the rack, the power system configured to deliver electrical power from the cell.

In Example 32, the subject matter of Example 31 optionally includes wherein the rack is configured to receive a plurality of cells respectively connected to a plurality of caps to connect the plurality of cells to the power system.

In Example 33, the subject matter of Example 32 optionally includes wherein each of the plurality of cells is a 3-volt power cell connected in series to each other by the power system to allow the power system to deliver power at 12-volts.

In Example 34, the subject matter of any one or more of Examples 31-33 optionally include wherein the cap includes a first opening and a second opening spaced apart from each other and extending through a top surface of the cap, the first opening configured to receive the positive terminal of the cell at least partially therethrough, and the second opening configured to receive the negative terminal of the cell at least partially therethrough.

In Example 35, the subject matter of Example 34 optionally includes wherein the cap includes a slot extending between a front surface of the cap and a rear surface of the cap, the slot configured to interface with the rack to secure the cell to the rack.

In Example 36, the subject matter of Example 35 optionally includes wherein the rack includes a first wall and a second wall opposite the first wall, the first wall and the second wall together at least partially forming an opening configured to receive the cell at least partially therein to secure the cell to the rack.

In Example 37, the subject matter of Example 36 optionally includes wherein the rack includes a rail extending from the first wall toward the second wall, the rail insertable into the slot of the cap to secure the cell to the rack.

In Example 38, the subject matter of Example 37 optionally includes a rack positive terminal connected to the rack and electrically connected to the power system, the rack positive terminal configured to interface with the positive terminal of the cell; and a rack negative terminal connected to the rack and electrically connected to the power system, the rack negative terminal configured to interface with the negative terminal of the cell electrically to connect the cell to the power system.

In Example 39, the subject matter of Example 38 optionally includes wherein the rail is insertable into the slot of the cap to orient the cell such that the negative terminal of the cell engages the rack negative terminal and the positive terminal of the cell engages the rack positive terminal when the cell is inserted into the opening of the rack.

In Example 40, the subject matter of any one or more of Examples 38-39 optionally include a first busbar connected to the rack and electrically connected to the power system, the rack positive terminal engageable with the first busbar to electrically connect the positive terminal of the cell to the first busbar; and a second busbar connected to the rack and electrically connected to the power system, the rack negative terminal engageable with the second busbar to electrically connect the negative terminal of the cell to the second busbar.

In Example 41, the subject matter of Example 40 optionally includes a positive biasing element connected to the rack and to the rack positive terminal, the positive biasing element configured to bias the rack positive terminal away from the first busbar; and a negative biasing element connected to the rack and to the rack negative terminal, the negative biasing element configured to bias the rack negative terminal away from the second busbar.

In Example 42, the subject matter of Example 41 optionally includes wherein the positive terminal of the cell is engageable with the rack positive terminal to overcome the positive biasing element to cause the rack positive terminal to engage the first busbar, and wherein the negative terminal of the cell is engageable with the rack negative terminal to overcome the negative biasing element to cause the rack negative terminal to engage the second busbar to electrically connect the cell to the power system.

In Example 43, the subject matter of any one or more of Examples 31-42 optionally include a plurality of caps including the cap, the plurality of caps securable to a plurality of cells, respectively, the plurality of cells including the cell, each of the plurality of caps configured to receive a positive terminal and a negative terminal of one cell of the plurality of cells, at least partially therethrough, wherein the rack is configured to receive the plurality of caps secured to respective ones of the plurality of cells to secure the plurality of cells to the rack; and a power circuit connected to the rack and electrically connectable to the positive terminal and the negative terminal of each of the plurality of cells when the plurality of cells are received within the rack, the power circuit configured to deliver electrical power from the plurality of cells.

In Example 44, the subject matter of any one or more of Examples 42-43 optionally include a plurality of rack positive terminals connected to the rack and electrically connected to the power circuit, the plurality of rack positive terminals configured to interface with respective ones of the positive terminal of the plurality of cells; and a plurality of rack negative terminals connected to the rack and electrically connected to the power circuit, the plurality of rack negative terminals configured to interface with respective ones of the negative terminal of the plurality of cells to electrically connect the plurality of cells to the power circuit.

In Example 45, the subject matter of Example 44 optionally includes a controller connected to the power circuit and configured to selectively deliver power from the plurality of cells.

In Example 46, the subject matter of Example 45 optionally includes a charge hold circuit connected to the power circuit and connected to the controller, the charge hold circuit including a hold capacitor, the controller configured to selectively connect the hold capacitor to one of the plurality of cells.

In Example 47, the subject matter of Example 46 optionally includes a plurality of sensors connected to respective ones of the plurality of cells, each of the plurality of sensors configured to generate a sensor signal based on a charge characteristic of the respective one of the plurality of cells.

In Example 48, the subject matter of Example 47 optionally includes wherein the controller is configured to determine the charge characteristic of each of the plurality of cells based on the sensor signal.

In Example 49, the subject matter of any one or more of Examples 45-48 optionally include wherein the controller is configured to determine which of the plurality of cells has a low charge.

In Example 50, the subject matter of Example 49 optionally includes wherein the controller is configured to connect the hold capacitor to the one of the plurality of cells that has the low charge.

In Example 51, the subject matter of Example 50 optionally includes a charge balance circuit connected to the power circuit and connected to the controller, the charge balance circuit including a balance capacitor, the controller configured to selectively connect the balance capacitor to one of the plurality of cells.

In Example 52, the apparatuses or method of any one or any combination of Examples 1-51 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A multi-cell battery system comprising:
a cap securable to a cell, the cap configured to receive a positive terminal and a negative terminal of the cell at least partially therethrough;
a rack configured to receive the cap secured to the cell to secure the cell to the rack; and
a power system connected to the rack and electrically connectable to the positive terminal and the negative terminal of the cell when the cell is received within the rack, the power system configured to deliver electrical power from the cell.

2. The multi-cell battery system of claim 1, wherein the rack is configured to receive a plurality of cells respectively connected to a plurality of caps to connect the plurality of cells to the power system.

3. The multi-cell battery system of claim 2, wherein each of the plurality of cells is a 3-volt power cell connected in series to each other by the power system to allow the power system to deliver power at 12-volts.

4. The multi-cell battery system of claim 1, wherein the cap includes a first opening and a second opening spaced apart from each other and extending through a top surface of the cap, the first opening configured to receive the positive terminal of the cell at least partially therethrough, and the second opening configured to receive the negative terminal of the cell at least partially therethrough.

5. The multi-cell battery system of claim 4, wherein the cap includes a slot extending between a front surface of the cap and a rear surface of the cap, the slot configured to interface with the rack to secure the cell to the rack.

6. The multi-cell battery system of claim 5, wherein the rack includes a first wall and a second wall opposite the first wall, the first wall and the second wall together at least partially forming an opening configured to receive the cell at least partially therein to secure the cell to the rack.

7. The multi-cell battery system of claim 6, wherein the rack includes a rail extending from the first wall toward the second wall, the rail insertable into the slot of the cap to secure the cell to the rack.

8. The multi-cell battery system of claim 7, comprising:
a rack positive terminal connected to the rack and electrically connected to the power system, the rack positive terminal configured to interface with the positive terminal of the cell; and
a rack negative terminal connected to the rack and electrically connected to the power system, the rack negative terminal configured to interface with the negative terminal of the cell electrically to connect the cell to the power system.

9. The multi-cell battery system of claim 8, wherein the rail is insertable into the slot of the cap to orient the cell such that the negative terminal of the cell engages the rack negative terminal and the positive terminal of the cell engages the rack positive terminal when the cell is inserted into the opening of the rack.

10. The multi-cell battery system of claim 8, comprising:
a first busbar connected to the rack and electrically connected to the power system, the rack positive terminal engageable with the first busbar to electrically connect the positive terminal of the cell to the first busbar; and
a second busbar connected to the rack and electrically connected to the power system, the rack negative terminal engageable with the second busbar to electrically connect the negative terminal of the cell to the second busbar.

11. The multi-cell battery system of claim 10, comprising:
a positive biasing element connected to the rack and to the rack positive terminal, the positive biasing element configured to bias the rack positive terminal away from the first busbar; and
a negative biasing element connected to the rack and to the rack negative terminal, the negative biasing element configured to bias the rack negative terminal away from the second busbar.

12. The multi-cell battery system of claim 11, wherein the positive terminal of the cell is engageable with the rack positive terminal to overcome the positive biasing element to cause the rack positive terminal to engage the first busbar, and wherein the negative terminal of the cell is engageable with the rack negative terminal to overcome the negative biasing element to cause the rack negative terminal to engage the second busbar to electrically connect the cell to the power system.

13. The multi-cell battery system of claim 1, comprising:
a plurality of caps including the cap, the plurality of caps securable to a plurality of cells, respectively, the plurality of cells including the cell, each of the plurality of caps configured to receive a positive terminal and a negative terminal of one cell of the plurality of cells, at least partially therethrough, wherein the rack is configured to receive the plurality of caps secured to respective ones of the plurality of cells to secure the plurality of cells to the rack; and
a power circuit connected to the rack and electrically connectable to the positive terminal and the negative terminal of each of the plurality of cells when the plurality of cells are received within the rack, the power circuit configured to deliver electrical power from the plurality of cells.

14. The multi-cell battery system of claim 12, comprising:
a plurality of rack positive terminals connected to the rack and electrically connected to the power circuit, the plurality of rack positive terminals configured to interface with respective ones of the positive terminal of the plurality of cells; and
a plurality of rack negative terminals connected to the rack and electrically connected to the power circuit, the plurality of rack negative terminals configured to interface with respective ones of the negative terminal of the plurality of cells to electrically connect the plurality of cells to the power circuit.

15. The multi-cell battery system of claim 14, comprising:
a controller connected to the power circuit and configured to selectively deliver power from the plurality of cells.

16. The multi-cell battery system of claim 15, comprising:
a charge hold circuit connected to the power circuit and connected to the controller, the charge hold circuit including a hold capacitor, the controller configured to selectively connect the hold capacitor to one of the plurality of cells.

17. The multi-cell battery system of claim 16, comprising:
a plurality of sensors connected to respective ones of the plurality of cells, each of the plurality of sensors configured to generate a sensor signal based on a charge characteristic of the respective one of the plurality of cells.

18. The multi-cell battery system of claim 17, wherein the controller is configured to determine the charge characteristic of each of the plurality of cells based on the sensor signal.

19. The multi-cell battery system of claim 15, wherein the controller is configured to determine which of the plurality of cells has a low charge.

20. The multi-cell battery system of claim 19, wherein the controller is configured to connect the hold capacitor to the one of the plurality of cells that has the low charge.

21. The multi-cell battery system of claim 20, comprising:
a charge balance circuit connected to the power circuit and connected to the controller, the charge balance circuit including a balance capacitor, the controller configured to selectively connect the balance capacitor to one of the plurality of cells.

22. The multi-cell battery system of claim 21, wherein the controller is configured to connect the balance capacitor to the one of the plurality of cells that has the low charge.
